(19) United States
(12) Patent Application Publication
(10) Pub. No.: US 2019/0310879 A1
(43) Pub. Date: Oct. 10, 2019

(54) SYSTEMS AND METHODS FOR AUTOMATICALLY MANAGING SCRIPTS FOR EXECUTION IN DISTRIBUTED COMPUTING ENVIRONMENTS

(71) Applicant: Citrix Systems, Inc., Fort Lauderdale, FL (US)

(72) Inventors: Leo C. Singleton, IV, Fort Lauderdale, FL (US); Avijit Gahtori, Fort Lauderdale, FL (US); Kim G. Henkel, Fort Lauderdale, FL (US); Costin Denisov, Fort Lauderdale, FL (US); Caitlin Brandman, Fort Lauderdale, FL (US)

(21) Appl. No.: 15/945,547

(22) Filed: Apr. 4, 2018

(51) Int. Cl. G06F 9/46; G06F 9/48; H04L 29/08

(52) U.S. Cl. CPC G06F 9/468; H04L 67/10; H04L 67/34; G06F 9/48

(57) ABSTRACT

Aspects of the present disclosure involve automatically generating a script for, e.g., capturing configuration information associated within software services and related computing components accessible throughout a network (e.g., a cloud). The script may be executed to capture such data traffic of the software deployed within the network.

### TECHNICAL FIELD

Aspects of the present disclosure relate to cloud computing networks, and in particular, to cloud computing environments enabling the execution of scripts and/or workflows.

### BACKGROUND

Cloud computing typically involves the continuous provisioning, monitoring, and updating of various computing components and cloud services. In order to implement any given modification, upgrade, and/or the like, often times a developer must develop and execute one or more independent scripts and access various independent environments (e.g., test and production environments) associated with the cloud deployment to implement the modifications or upgrades. Typically, in such scenarios, the scripts are not well organized, not well-contained, etc., and often require labor-intensive interaction from developers to execute.

Alternatively or additionally, when attempting to use a script to implement a modification, upgrade, and/or the like, the developer may be required to contact an operational engineer that has the appropriate credentials to validate and permanently execute the requested change at the desired computing component and/or cloud service. Thus, the scripts/code required to resolve the changes requests may be distributed amongst different developers/operational engineers to effectuate the change, all of which is time consuming, labor-intensive, and expensive.

It is with these problems, among others, that aspects of the present disclosure where conceived.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 is an example computing environment for processing scripts to generate a workflow for execution at one or more computing components and services, according to aspects of the present disclosure.

FIG. 2 is flow chart or process for processing scripts to generate a workflow for execution at one or more computing components and services, according to aspects of the present disclosure.

FIG. 3 is a diagram of a computing system specifically implemented for processing scripts to generate a workflow for execution at one or more computing components and services, according to aspects of the present disclosure, according to aspects of the present disclosure.

### DETAILED DESCRIPTION

Aspects of the present disclosure involve a system that consolidates, coordinates, and/or otherwise automates multiple scripts into an executable process, such as a workflow. The multiple scripts are configured to implement various upgrades, modifications, configurations, and/or the like at various computing components and/or computing devices deployed within a distributed communications network (e.g., a cloud network). Each of the multiple scripts included in the workflow may be functionally independent and written in various programming languages and/or dependent on the output of other functionally independent scripts.

The generated workflow consolidates and coordinates the scripts (and their various dependencies and requirements) into a single workflow or executable process that may be executed at the various computing components and/or computing devices of the distributed communications network. In one specific example, the workflows may contain the credentials necessary to validate and authorize the execution of a script at a given computing device or computing component. In another example, the credentials used to execute the script may be maintained by the system and may be different than the credentials used to access the machines, components, etc., on which the scripts may be executed. Separating the credentials from the enables the system to control access to the scripts and/or the machines, components, etc.

The generated workflow may be executed within the distributed network of computing devices on demand or at any point, thereby causing the upgrade or modification to associated with the incorporated script(s) to be automatically implemented at the various computing devices or computing components deployed within the distributed network.

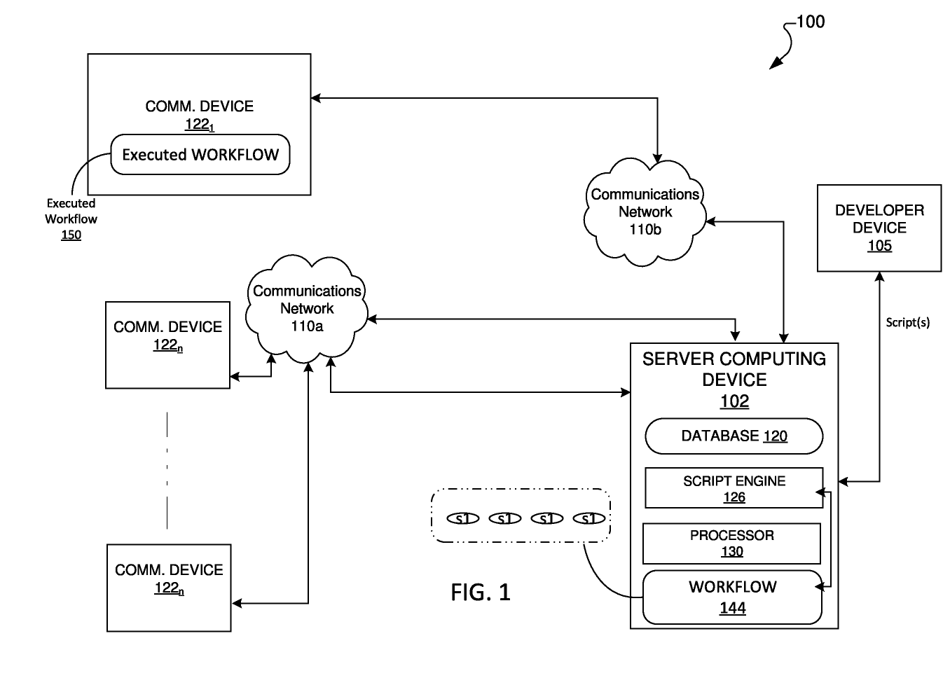

FIG. 1 provides and illustration of an implementation of a computing system or architecture 100 that consolidates and coordinates multiple scripts into a single executable process or workflow, according to aspects of the present disclosure. As illustrated, FIG. 1 includes various computing devices communicating through one or more networks 110a, 110b. The one or more networks may be an IP-based telecommunications network, the Internet, an intranet, a local area network, a wireless local network, a content distribution network, or any other type of communications network, as well as combinations of networks. For example, in one particular embodiment, the networks 110a and 110b may be a telecommunications network including fiber-optic paths between various network elements, such as servers, switches, routers, and/or other optical telecommunications network devices that interconnect to enable receiving and transmitting of information between the various elements as well as users of the network. In one specific examples, the networks 110a and 110b may represent various virtual networks, such as virtual networks for development, staging, and production, and/or networks for various geographical regions.

The computing environment 100 includes a server computing device 102 that is in communication with communication devices (122₁, 122₂, . . . , 122ₙ) located at one or more geographic locations. The server computing device 102, may be a processing device that functionally connects or otherwise communicates (e.g., using the one or more networks 110a, 100b) with communication devices (122₁, 122₂, . . . , 122ₙ) included within the computing environment 100. The communication devices (122₁, 122₂, . . . , 122ₙ) may be any of, or any combination of, a personal computer; handheld computer; mobile phone; digital assistant; smart phone; server; application; and the like. In one embodiment, each of the communication devices (122₁, 122₂, . . . , 122ₙ) may include a processor-based platform that operates on any suitable operating system, such as Microsoft® Windows®, Linux®, Android, and/or the like that is capable of executing software processes, software, applications, etc. The communication devices (122₁, 122₂, . . . , 122ₙ) devices may also include a communication system to communicate with the various components of the computing environment 100 via a wireline and/or wireless communications, such as networks 110a, 100b. In the illustrated embodiment, some of the communication devices (122₁, 122₂, . . . , 122ₙ) are connected to a single communications network. It is contemplated that every communication devices (122₁, 122₂, . . . , 122ₙ) may be connected to a single network. Alternatively, some of the communication devices (122₁, 122₂, . . . , 122ₙ) may be connected to multiple networks.

The server computing device 102 includes a database 120, a script execution engine 126, and a processor 130. The database 120 may be a database, data store, storage and/or the like, for storing data involved in generating workflows from multiple scripts. In one specific example, the database 120 may store scripts and associated credentials for authorizing access and execution of a script at one or more of the communication devices (122₁, 122₂, . . . , 122ₙ) included within the computing environment 100.

The script engine 126 provides a mechanism that automatically consolidates and coordinates multiple scripts into a single executable process or workflow 144. In particular, the script engine 144 may obtain script(s) from a developer device 105, which may be any of, or any combination of, a personal computer; handheld computer; mobile phone; digital assistant; smart phone; server; application; and the like, similar to the communication devices (122₁, 122₂, . . . , 122ₙ). For example, a user at the developer device 105 may interact with one or more interactive interfaces/input forms (e.g. a user-interface or graphical user-interface (GUI)) may be generated for providing scripts to the server computing device 102. In particular, the server device 102, via the processor 130, may provide a mechanism, process, and/or application, which, when executed, generates interfaces for receiving or otherwise defining scripts from users. The interfaces may include interactive elements, such as buttons, forms, activity logs, fields, streaming capabilities for streaming script data, selections, inputs, streams, images, etc. For example, in one embodiment, one or more web pages may be displayed that allow users to access to provide scripts. In such a scenario, the server computing device 102 functions as a web server.

In some embodiments, the script execution engine 126 may receive a script and validate credentials corresponding to the script. More specifically, various devices within the communication devices (122₁, 122₂, . . . , 122ₙ) devices may require the validation and/or verification of credentials to enable actions be performed by a script at the respective device. Thus, the script engine 126 may process credentials (e.g., username and password) associated with the script and/or the computing device of the communications network 100 upon which the script may be executed. When successful, the validated credentials may be stored in the generated workflow 144 (illustrated as s1, s1, s1) so that the verification and/or validation of the script does not need to be performed during subsequent executions of the script or workflow containing the script. In other embodiments, some other indication of a validation of the credentials may be stored or otherwise associated with the workflow 144.

The workflow 144 may be executed (illustrated at 150) within the computing environment 100, for example at the communication devices (122₁, 122₂, . . . , 122ₙ), to implement the functions of each individual script included within the generated workflow 144, regardless of whether the scripts are written in different programming languages (e.g., Powershell, Python, Containers) or regardless of whether the scripts depend on the functions of other scripts. Thus, in the instance where each of the script is initially generated in a different programming language or, as stated above, the generated workflows may incorporate the necessary credentials, permissions, parameters, etc., required to automatically validate the scripts execution within the computing environment 100. Thus, during execution of the workflow, the credentials do not have to be re-validated or verified.

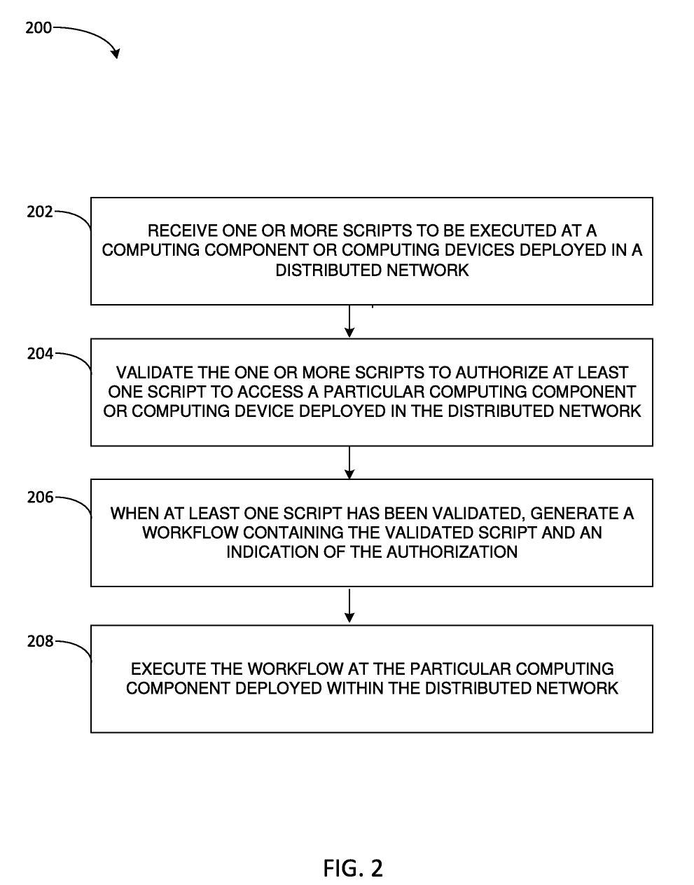

Referring now to FIG. 2 and with reference to FIG. 1, a process 200 for processing scripts to generate a workflow to implement a modification at one or more computing components deployed within a distributed computing network is provided. As illustrated, process 200 begins at step 202, with obtaining one or more scripts to be executed on one or more computing components or computing devices deployed within a distributed computing network (e.g., network 100). Referring to FIG. 1, the script engine obtains one or more scripts. The scripts may be pre-stored in the database 120 or received in real-time from the developer device 105. Generally speaking, a script represents a series of commands within a file that is capable of being executed without being compiled. Thus, scripts may be used to perform any number of functions at a computing device or computing component. For example, a script may be used to provision and initialize computing devices, modify and/or upgrade computing devices and/or computing components, power-cycle a computing device and/or computing component, access data maintained at a computing device and/or computing component, and/or the like. Typical parameters used to run a given script identify the component(s) the script should run on, as well as parameters representing the credentials for each device in order to run.

Referring again to FIG. 2, at step 204, the at least one script of the one or more scripts are validated to ensure the script has authorization to access a specific or particular computing component or computing device of the distributed network. Referring to FIG. 1, the processor 130 processes any credentials corresponding to the obtained script to authorize whether a particular script can access a specific communication device (e.g., communication devices (122₁, 122₂, . . . , 122ₙ)) within the computing environment 100.

In one specific example, the system may include store or otherwise maintain credentials for all of the machines, computing devices, and/or the like, on which a script may be executed. More specifically, the system may store unique credentials for individual users, such as developers and engineers, that enable access to the system (not the actual machine credentials on which the script is executed) and a unique set of permissions. But the credentials are not the same as and are not stored on the machines (e.g., local development machines) and/or computing components on which a given script will be executed. For example, a developer may only have permissions to run scripts on a single Virtual Machine (“VM”) belonging to that developer. Or maybe the developer has read-only permissions to access all VMs of a network, but read/write access to only a subset of all of the VMs. The system enforces these permissions on a per-user level, not a per-script level. So a developer may write a script, upload it to the system, execute it against an applicable VM (e.g., a development VM) for testing and hand the script off to an operations engineer. The operations engineer has permissions in the system to run the exact same script on more VMs, including production ones. Thus, the system generates different credentials to the same script based on what a specific user requests to run the script.

In another example, the system may also control access to the output of a script. A script does not necessarily deploy services or change configuration—it could also function to, for example, “count the number of customers who use feature X.” It's possible that the developer who wrote the script does not have permission to see its output when run against certain customers. The system controls such permissions and credentials for the user executing the script.

Referring again to FIG. 2, at step 206, when the script has been validated, a workflow is generated that contains or otherwise encapsulates the validated script(s). In some instances, the workflow may also contain an indication that a particular script(s) contained within the workflow have authorization to access a particular computing device or computing component. In one specific example, the workflow represents a sequence of scripts that should be executed to perform a specific job. The workflow is not equivalent to the actual script(s), but an abstraction of the scripts that controls the flow of information and execution of the functions associated with the script. Referring to FIG. 1, the processor 130 automatically manage and coordinates the hosting and executing of workflows for tasks such as: computing component and computing device provisioning and creation, modification, and deletion; recovery and backup; security group creation, deletion, and modification; user credentials management; and key rotation and credential management, among others.

In one specific example, the generated workflow may resolve a dependency of one or more of the input scripts provided by a user. At step 208, the generated workflow including one or more input scripts is executed at the applicable computing components deployed within the distributed network.

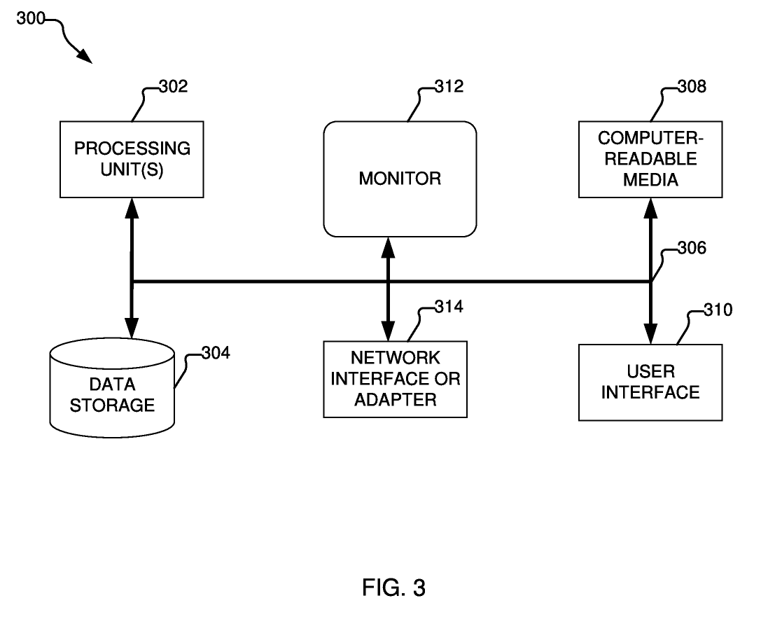

FIG. 3 illustrates an example of a suitable computing and networking environment 300 that may be used to implement various aspects of the present disclosure described in FIG. 1-3. As illustrated, the computing and networking environment 300 includes a general purpose computing device 300, although it is contemplated that the networking environment 300 may include one or more other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the computer 300 may include various hardware components, such as a processing unit 302, a data storage 304 (e.g., a system memory), and a system bus 306 that couples various system components of the computer 300 to the processing unit 302. The system bus 306 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 300 may further include a variety of computer-readable media 308 that includes removable/non-removable media and volatile/nonvolatile media, but excludes transitory propagated signals. Computer-readable media 308 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other media that may be used to store the desired information/data and which may be accessed by the computer 300.

Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The data storage or system memory 304 includes computer storage media in the form of volatile/nonvolatile memory such as read only memory (ROM) and random access memory (RAM). A basic input/output system (BIOS), containing the basic routines that help to transfer information between elements within the computer 300 (e.g., during start-up) is typically stored in ROM. RAM typically contains data and/or program modules that are immediately accessible to and/or presently being operated on by processing unit 302. For example, in one embodiment, data storage 304 holds an operating system, application programs, and other program modules and program data.

Data storage 304 may also include other removable/non-removable, volatile/nonvolatile computer storage media. For example, data storage 304 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media, described above and illustrated in FIG. 3, provide storage of computer-readable instructions, data structures, program modules and other data for the computer 300.

A user may enter commands and information through a user interface 310 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices are often connected to the processing unit 302 through a user interface 310 that is coupled to the system bus 306, but may be connected by other interface and bus structures, such as a parallel port, game port or a universal serial bus (USB). A monitor 312 or other type of display device is also connected to the system bus 306 via an interface, such as a video interface. The monitor 312 may also be integrated with a touch-screen panel or the like.

The computer 300 may operate in a networked or cloud-computing environment using logical connections of a network interface or adapter 314 to one or more remote devices, such as a remote computer. The remote computer may be a personal computer, a server, a router, a network PC, a peer device or other common network node, and typically includes many or all of the elements described above relative to the computer 300. The logical connections depicted in FIG. 3 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 300 may be connected to a public and/or private network through the network interface or adapter 314. In such embodiments, a modem or other means for establishing communications over the network is connected to the system bus 306 via the network interface or adapter 314 or other appropriate mechanism. A wireless networking component including an interface and antenna may be coupled through a suitable device such as an access point or peer computer to a network. In a networked environment, program modules depicted relative to the computer 300, or portions thereof, may be stored in the remote memory storage device.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A method comprising:
receiving, using a computing device, a script defining at least one function to be executed at a first computing component of one or more computing components deployed within a communications network;
validating, using the computing device, that the script is authorized to implement the function at the one or more computing components by identifying credentials associated with a first user requesting execution of the script at the first computing component, wherein the credentials associated with the first user are different than credentials used to directly access the first computing component; and
when the script is validated, generating, using the computing device, a workflow containing the script and an indication that the script has been authorized to perform the function at the first user component.

2. The method of claim 1, further comprising:
based on the indication, executing the workflow, using the computing device, thereby implementing the function at the first computing component.

3. The method of claim 1 further comprising:
validating that the script may be used to implement the at least one function at a second computing component of the one or more computing components by identifying credentials associated with a second user requesting execution of the script, wherein the credentials associated with the second user are different than the credentials used to directly access the first computing component; and
executing the script at the second computing component.

4. The method of claim 3, further comprising:
storing an indication in the workflow that the script has been authorized to perform the function at the second computing component.

5. The method of claim 1 further comprising executing the workflow at the one or more computing component of software service upon request by a user.

6. The method of claim 1, wherein the at least one script is received as input from a user.

7. A system comprising:
at least one computing device to:
receive a script defining at least one function to be executed at one or more computing components deployed within a communications network;
validate that the script is authorized to implement the function at the one or more computing components by identifying credentials associated with a first user requesting execution of the script at the first computing component, wherein the credentials associated with the first user are different than credentials used to directly access the first computing component; and
when the script is validated, generate a workflow containing the script and an indication that the script has been authorized to perform the function at the first user component.

8. The system of claim 7, wherein the at least one computing device is further configure to:
based on the indication, execute the workflow, using the computing device, thereby implementing the function at the first computing component.

9. The system of claim 7, wherein the computing device is further configured to:
validate that the script may be used to implement the at least one function at a second computing component of the one or more computing components by identifying credentials associated with a second user requesting execution of the script, wherein the credentials associated with the second user are different than the credentials used to directly access the first computing component; and
executing the script at the second computing component.

10. The system of claim 7, wherein the computing device is further configured to:
storing an indication in the workflow that the script has been authorized to perform the function at the second computing component.

11. The system of claim 7, wherein the computing device is further configured to:
storing an indication in the workflow that the script has been authorized to perform the function at the second computing component.

12. The method of claim 7, wherein the at least one script is received as input from a user.

13. A non-transitory computer readable medium encoded with instructions, the instructions, executable by a computing device, comprising:
receiving a script defining at least one function to be executed at one or more computing components deployed within a communications network;
validating that the script is authorized to implement the function at the one or more computing components by identifying credentials associated with a first user requesting execution of the script at the first computing component, wherein the credentials associated with the first user are different than credentials used to directly access the first computing component; and
when the script is validated, generating a workflow containing the script and an indication that the script has been authorized to perform the function at the first user component.

14. The non-transitory computer readable medium of claim 13, further comprising:
based on the indication, executing the workflow, using the computing device, thereby implementing the function at the first computing component.

15. The non-transitory computer readable medium of claim 13, further comprising:
validating that the script may be used to implement the at least one function at a second computing component of the one or more computing components by identifying credentials associated with a second user requesting execution of the script, wherein the credentials associated with the second user are different than the credentials used to directly access the first computing component; and
executing the script at the second computing component.

16. The non-transitory computer readable medium of claim 15, further comprising:
storing an indication in the workflow that the script has been authorized to perform the function at the second computing component.

17. The non-transitory computer readable medium 15, further comprising executing the workflow at the one or more computing component of software service upon request by a user.

18. The non-transitory computer readable medium 13, wherein the at least one script is received as input from a user.

19. The non-transitory computer readable medium 13, wherein the script is written in a language selected from at least one of BASH, PERL, Powershell, and Python.
